(19) United States
(12) Patent Application Publication
(10) Pub. No.: US 2026/0186752 A1
(43) Pub. Date: Jul. 2, 2026

(54) ARTIFICIAL INTELLIGENCE SEARCHING TOOL FOR ENTERPRISE SPECIFIC CODE GENERATION

(71) Applicant: Intuit Inc., Mountain View, CA (US)

(72) Inventors: Jothimani Kanthan GANAPATHI, Brentwood, CA (US); Jason Michael WEBB, Valley Center, CA (US); Amit KAUSHAL, Bengaluru (IN); Sumangal MANDAL, Kolkata (IN)

(73) Assignee: Intuit Inc., Mountain View, CA (US)

(21) Appl. No.: 19/006,739

(22) Filed: Dec. 31, 2024

(51) Int. Cl. G06F 8/35

(52) U.S. Cl. CPC G06F 8/35

(57) ABSTRACT

An artificial intelligence searching tool for enterprise specific code generation includes receiving a first version of a new functionality entry that includes multiple new pairs including a new prompt and a new response referencing a corresponding new code example and storing the new functionality entry in a clone of a code repository. The method further includes processing, by an LLM using information from the clone, a set of test prompts selected from the new pairs and the existing pairs. The method further includes identifying an accuracy level of the set of generated responses in selecting, from the clone, a corresponding code example for each of the set of test prompts, detecting, based on the accuracy level, a conflict between the first version and an existing functionality entry, and populating an owner interface with information regarding the conflict to obtain a second version of the new functionality entry.

### BACKGROUND

Large enterprise organizations often have internal code development. The code may be part of software packages that are used internally or externally to the large organization.

To assist in the development of code, software developers, whether or not part of the large organization, often search the Internet for information as to how to perform a particular function. For example, if a software developer wants to learn about encryption, then the software developer may search the Internet for encryption. The results that are returned may be a variety of techniques to perform the function that is generalized across a variety of organizations. However, large organizations often have proprietary techniques to perform certain functions. In such a scenario, Internet searches either cannot provide the requisite information or the proprietary technique is obfuscated in the variety of other techniques to perform the function. Additionally, searching tools that search internal codebases often hallucinate as the responses by the searching tool do not actually have the searched functionality. Thus, a problem exists in creating an internal searching tool that provides accurate responses for proprietary techniques used by an enterprise organization.

### SUMMARY

In general, in one aspect, one or more embodiments relate to a method that includes receiving, from an owner computing system via an owner interface, a first version of a new functionality entry that includes multiple new pairs, the new pairs each that includes a new prompt and a new response referencing a corresponding new code example of multiple new code examples, and storing the new functionality entry in a clone of a code repository, the clone and the code repository that includes multiple existing functionality entries that includes multiple existing pairs, the existing pairs each that includes an existing prompt and an existing response referencing a corresponding existing code example of the existing code examples. The method further includes processing, by an LLM using information from the clone, a set of test prompts selected from the new pairs and the existing pairs and that includes the new prompt and the existing prompt. Processing the set of test prompts generates a set of generated responses. The method further includes identifying an accuracy level of the set of generated responses in selecting, from the clone, a corresponding code example for each of the set of test prompts, detecting, based on the accuracy level, a conflict between the first version of the new functionality entry and an existing functionality entry of the existing functionality entries, and populating an owner interface with information regarding the conflict to obtain a second version of the new functionality entry.

In general, in one aspect, one or more embodiments relate to a system that includes at least one computer processor, a clone of a code repository that includes multiple existing functionality entries that includes multiple existing pairs. The existing pairs each that includes an existing prompt and an existing response referencing a corresponding existing code example of the existing code examples. The system also includes an interface executing on the at least one computer processor configured to receive, from an owner computing system, a first version of a new functionality entry that includes multiple new pairs, the new pairs each that includes a new prompt and a new response referencing a corresponding new code example of multiple new code examples. The system also includes a code ingest process executing on the at least one computer processor configured to perform operations that includes storing the new functionality entry in the clone of the code repository, identifying an accuracy level of a set of generated responses in selecting, from the clone, a corresponding code example for each of a set of test prompts, detecting, based on the accuracy level, a conflict between the first version of the new functionality entry and an existing functionality entry of the existing functionality entries, and populating owner interface with information regarding the conflict to obtain a second version of the new functionality entry. The system also includes a large language model (LLM) configured to process, by using information from the clone, the set of test prompts selected from the new pairs and the existing pairs and that includes the new prompt and the existing prompt. Processing the set of test prompts generates the set of generated responses.

In general, in one aspect, one or more embodiments relate to a method that includes receiving, via a search interface, a consumer prompt requesting a set of code examples for a particular functionality, processing, by an LLM, the consumer prompt by identifying, from a subset of multiple functionality entries in a code repository, matching metadata having metadata matching the consumer prompt, selecting a functionality entry corresponding to the matching metadata, the functionality entry that includes at least one code example with the particular functionality, selecting a code example from the at least one code example based on the consumer prompt and the matching metadata, and presenting, in the search interface, the code example.

Other aspects of one or more embodiments will be apparent from the following description and the appended claims.

### BRIEF DESCRIPTION OF DRAWINGS

FIG. 1 shows a system in accordance with one or more embodiments.

FIG. 2 shows an example of a functionality entry in accordance with one or more embodiments.

FIG. 3 shows a flowchart in accordance with one or more embodiments.

FIG. 4A and FIG. 4B show an example in accordance with one or more embodiments.

FIG. 5A and FIG. 5B show a computing system in accordance with one or more embodiments.

Like elements in the various figures are denoted by like reference numerals for consistency.

### DETAILED DESCRIPTION

One or more embodiments are directed to an artificial intelligence searching tool for enterprise code generation. The searching tool includes a large language model (LLM) that is configured to search a code repository storing functionality entries. Each functionality entry is a collection of code and information for achieving a particular function. For example, one functionality entry may be how to perform encryption of communications while another functionality may be for logging particular operations. The code in the functionality entry includes examples for the consumer (e.g., a software developer or other consumer of code) to incorporate into the consumer's software. The information with the code includes metadata and example prompts and responses for searching for the functionality entry.

Because LLM's suffer from hallucinations, the functionality entries are processed through an LLM specific validation process that identifies the type of conflicts between functionality entries. In the LLM specific validation procedure, a clone of the code repository is generated. The clone includes existing validation entries and the new validation entry. The validation process sends the test prompts to the LLM from the example prompts of the existing validation entries and the new validation entry. Based on the results, conflicts, such as usage of the same acronym for different terms, are identified and are used to populate a user interface. Through the interface, the conflicts are resolved, and the functionality entry is added to the code repository for searching.

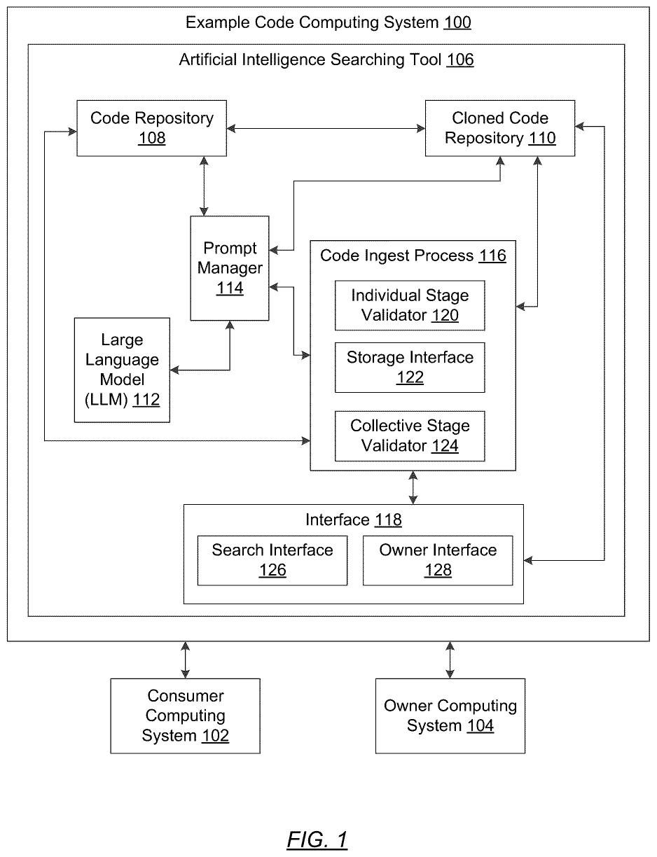

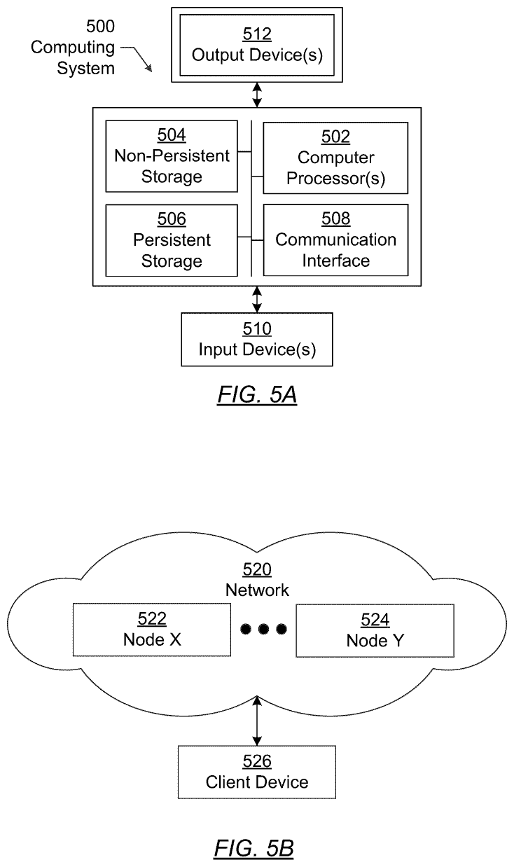

Attention is now turned to the figures. FIG. 1 shows a system in accordance with one or more embodiments. As shown in FIG. 1, the system includes an example code computing system (100) connected to a consumer computing system (102) and an owner computing system (104). The various computing systems may correspond to the computing system discussed below and in relation to FIG. 5A and FIG. 5B. The use of the term “owner” and “consumer” is with respect to a particular functionality entry. The owner computing system (104) is the computing system of the owner of a functionality entry while the consumer computing system (102) is the computing system of the consumer of the functionality entry. The owner is the software developer or software development team that creates or publishes the functionality entry. For example, the owner may be the person or team that creates a software library that performs the function. The owner may then create or define a functionality entry that helps developers to use the software library. The consumer of the functionality entry is the person or team that is searching for the functionality entry. Namely, the consumer is requesting the search.

The example code computing system (100) is a centralized computing system that executes the artificial intelligence searching tool (106) in accordance with one or more embodiments. The example code computing system (100) may interface with multiple computing systems, such as via a network (not shown), to provide the functionality of the artificial intelligence searching tool (106).

The artificial intelligence searching tool (106) includes a code repository (108), a clone of the code repository (110), an LLM (112), a prompt manager (114), a code ingest process (116), and an interface (118). Each of these components is described below.

A repository is a type of storage unit or device (e.g., a file system, database, data structure, or any other storage mechanism) for storing data. The repository may include multiple different, potentially heterogeneous, storage units and/or devices. A code repository (e.g., a code repository (108), a clone of the code repository (110)) is a type of repository that stores functionality entries. The code repository (108) is used in production and may be queried against. The clone code repository (110) is a copy of the code repository (110) that may include additional unvalidated functionality entries. Specifically, the cloned code repository (110) is a copy that is used for validation purposes. By validating in the cloned code repository (110), one or more embodiments detect hallucinations that may occur and prevent hallucinations at the inference stage when consumers are querying the code repository (108). In one or more embodiments, the cloned code repository has only a portion of the code repository. For example, the cloned code repository may only have a copy of the vector database portion of the code repository while omitting the remaining portion of the code repository.

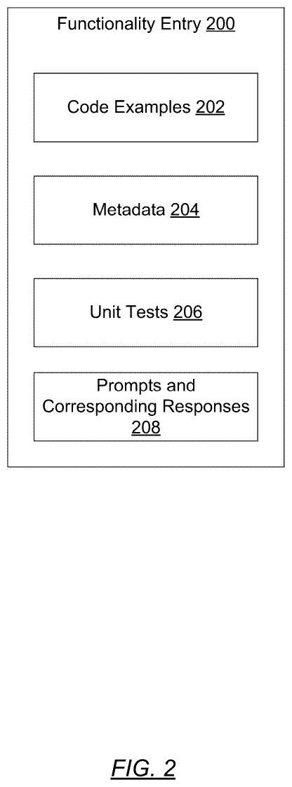

The functionality entries in the code repository (108) and cloned code repository (110) includes example code and information about the code. Each functionality entry is for a particular software function. Namely, the function is a task that the computing system performs. For example, a function may be to perform encryption, log information, store a value, perform a particular calculation, authenticate a user, etc. FIG. 2 shows a diagram of a functionality entry (200) in accordance with one or more embodiments. As shown in FIG. 2, a functionality entry (200) may include one or more code examples (202), metadata (204), one or more unit tests (206), and one or more prompts and corresponding responses (208).

The code examples (202) are different examples of software code to perform the particular function. For example, if a software library performs the function, the code examples may each be different example code segments that include a call to the software library.

The metadata (204) is information describing the functionality entry. For example, the metadata (204) may include a description of the function, a narrative about the function and the examples, information about the owner, timestamp of a last update, and any other information.

The one or more unit tests (206) are example inputs and corresponding correct outputs when the function is correctly performed. For example, the unit tests (206) are the tests for testing just the code corresponding to the function when incorporated into consumer's software. By including the unit test, the consumer can confirm that the function is correctly performed by the consumer's software.

The prompt and corresponding responses (208) are example inputs and outputs to the LLM when searching for the functionality entry (200). The prompt and corresponding responses (208) are arranged as pairs, whereby each prompt is linked to a corresponding response. Namely, a pair include a prompt and a response. The prompt is an example of a search query that may be submitted to the LLM. The response is the example of the output that should be provided by the LLM. In one or more embodiments, the response is a unique identifier of the functionality entry. As another example, the response may be a particular code example of the code examples (202), a ranked ordering of the code example (202) based on relevancy, or identifiers of one or more of the code examples (202).

Returning to FIG. 1, the code repository (108) and the cloned code repository (110) may both include a vector database indexed by a retrieval augmented generation (RAG) indexer and a storage server. The RAG indexer may be configured to index the new code examples and the metadata in the functionality entries to generate vectors that are stored in the vector database. The storage server may be configured to store the functionality entries.

The LLM (112) is configured to interact with the user and identify matching code examples from the code repository (108) and the cloned code repository (110). The LLM (112) is a type of artificial intelligence (AI) program that performs natural language processing to recognize and generate text, images, and other content. The LLM (112) may have hundreds of thousands to trillions of parameters. Examples of LLMs include versions of ChatGPT®, Llama®, Mistral-7B®, and proprietary LLMs, etc.

The prompt manager (114) is configured to generate the LLM prompt from the user prompt. Specifically, the prompt manager (114) is configured to encapsulate a user prompt into the LLM prompt with a system instruction and context. The system instruction includes specific instructions of an application, not shown, that are further provided to the LLM (112) to process the user prompt. The system instruction may include, for example, the format of the LLM response provided by the LLM (112), constraints on the LLM response, information as to how to provide the LLM response. The context is information specific to the user prompt, such as by being directed to information about the user, the account of the user, the navigational patterns of the user, and other information. The prompt manager (114) may include a RAG system (not shown). The RAG system is configured to search the code and metadata for the possibly matching code examples. The RAG system may further include functionality to select a subset of the functionality entries from the cloned code repository (110) or the code repository (108) and add the subset as part of the context of the prompt to the LLM.

The interface (118) is an application programming interface (API) or graphical user interface (GUI) that is configured to interact with the owner and the consumer. The interface (118) may include various GUI widgets (e.g., text boxes, buttons, and other user interface elements) to receive information from a user. The interface (118) includes a search interface (126) and an owner interface (128). The search interface (126) is an interface for a consumer to search the code repository (108). The owner interface (128) is an interface for owners to provide functionality entries. The owner interface (128) is further configured to interact with an owner based on validation of the functionality entries.

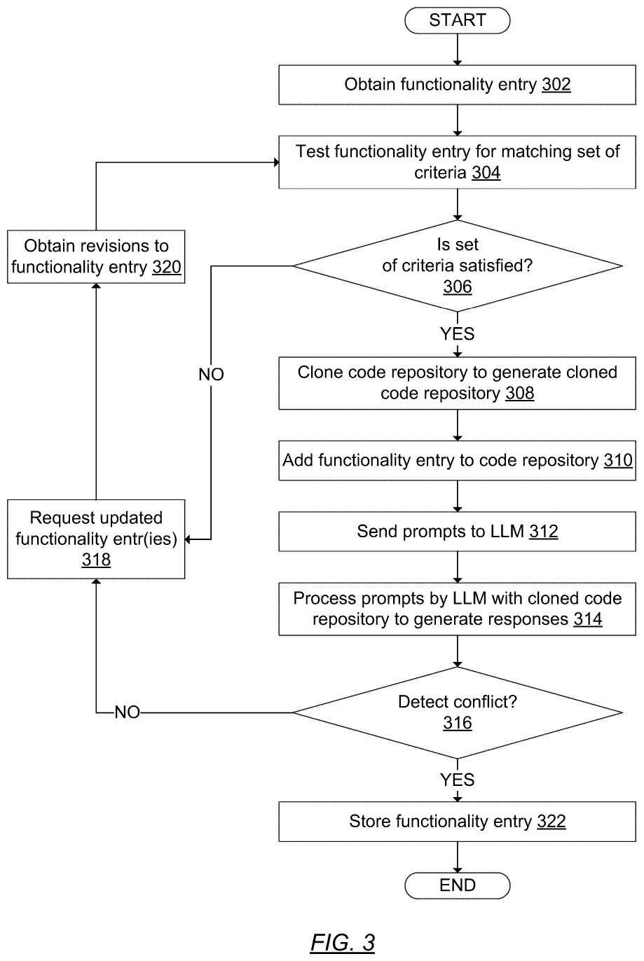

The interface (118) is connected to a code ingest process (116). The code ingest process (116) is a software process that is configured to receive and validate functionality entries. The code ingest process (116) is further configured to interact with the owner and LLM to perform the validation. In one or more embodiments, the code ingest process (116) includes an individual stage validator (120), a storage interface (122), and a collective stage validator (124). The individual stage validator (120) is configured to validate new functionality entries individually. The storage interface (122) is configured to interface with the code repository (108) and the cloned code repository (110) to store and retrieve functionality entries from the respective storage. The collective stage validator (124) is configured to perform validation on the group of functionality entries as a whole. For example, the collective stage validator (124) is configured to determine whether conflict exists between functionality entries. The validation process of the code ingest process (116) is discussed in FIG. 3.

While FIG. 1 shows a configuration of components, other configurations may be used without departing from the scope of one or more embodiments. For example, various components may be combined to create a single component. As another example, the functionality performed by a single component may be performed by two or more components.

FIG. 3 shows a flowchart in accordance with one or more embodiments. The method of FIG. 3 may be implemented using the system of FIG. 1 and FIG. 2 and one or more of the steps may be performed on or received at one or more computer processors. While the various steps in FIG. 3 are presented and described sequentially, at least some of the steps may be executed in different orders, may be combined or omitted, and at least some of the steps may be executed in parallel. Furthermore, the steps may be performed actively or passively.

In Block 302, a new functionality entry is obtained. Obtaining the new functionality entry includes receiving from an owner computing system via an owner interface, a first version of a new functionality entry that includes new pairs. The new pairs each include a new prompt and a new response referencing a corresponding new code example of the multiple new code examples.

In Block 304, the functionality entry is tested for matching a set of criteria in one or more embodiments. Specifically, the individual stage validator performs initial validation of the functionality entry. The set of criteria includes different requirements for different parts of the functionality entry. The different requirements may be defined by best practices for each particular part. For example, during an initial stage of validating the new functionality entry, code examples are tested for complying with a first set of requirements and metadata, and at least one unit test are tested for complying with a second set of requirements. The testing during the initial stage may be performed by parsing the code examples and determining whether the code examples satisfy the programming language requirements of the software code. The testing may also be to test for annotations, confirm that variables are well defined, and perform other testing. The requirements for the metadata may be a grammatically correct description, an identification of the function, and having other predefined information. The testing for unit testing may be to confirm that each set of inputs has a corresponding set of outputs. Other unit testing may be performed.

In Block 306, a determination is made whether the set of criteria is satisfied. If the set of criteria is not satisfied, an update to the functionality entry is requested in Block 318. In Block 320, one or more revisions to the functionality entry are received. When validation failure occurs, the owner may interact with the validation process through the owner interface to correct the functionality entry. Thus, the owner interface identifies at least one of the first set of requirements and the second set of requirements that are failed by the new functionality entry. The particular part of the functionality entry that failed may be highlighted in the owner interface, and an explanation of the failure may be displayed. The owner may submit a correction via the GUI widgets of the owner interface. Thus, a correction of the new functionality entry is received via the GUI widgets to generate the revised version. When the criteria are satisfied, the flow may proceed to Block 308.

In Block 308, the code repository is cloned to generate a cloned code repository. Existing functionality entries are copied to the clone so that the clone is a copy of the code repository. The data being cloned is known good data. Namely, the unit tests passed for all the functionality entries that are being cloned to the clone repository. The clone of the vector store of embeddings of the functionality entries is copied. Thus, the clone and the code repository include existing functionality entries that include existing pairs of existing prompts and an existing responses referencing a corresponding existing code example. Notably, the clone may only include a portion of the existing functionality entries.

In Block 310, the new functionality entry is stored in the clone of the code repository. The new functionality entries are not stored in the production version of the code repository until validated in one or more embodiments. In some embodiments, to store the new functionality entry, the new code examples and corresponding metadata are indexed by the RAG indexer to generate one or more vectors. The vectors are stored in the vector database. Further, the new code examples, the corresponding metadata, and the new pairs are stored in the storage server.

In Block 312, the prompts are sent to the LLM. In one or more embodiments, the prompts are used as input to the prompt manager that adds instructions and context to the prompts. For example, independently, for each prompt, the prompt manager may add context that includes a subset of the functionality entries in the clone. To identify the subset, a RAG system in the prompt manager queries the clone to identify a subset of possible matching functionality entries. For example, the RAG system may include a vector embedding model that generates a vector embedding of the prompt and then searches the vector database with the vector embedding for vectors that are within a threshold degree of similarity to the prompt. The RAG system may add the vectors to the prompt as the context. The vectors represent possibly matching functionality entries. After adding the context and instructions to each prompt, the prompts are sent to the LLM using the API of the LLM.

In Block 314, the LLM processes the prompts using the information from the cloned code repository to generate a set of generated responses. For each prompt, the LLM may process the vectors in the prompt with the requested information in the prompt to identify a match.

Block 312 and 314 may be performed using testing pairs of prompts and responses. Testing pairs are selected from the new pairs of the new functionality entries and the existing pairs of existing functionality entries. The testing pairs include test prompts that is each one of the new prompt and the existing prompt. The selection may be based on a predefined set of criteria.

The generated responses identify a code example. Because each test prompt is associated with a testing pair, and the response in the testing pair also identifies a code example, the accuracy level may be determined. The accuracy level is determined for each functionality entry. Namely, the accuracy level for the functionality entry is the percentage of testing pairs in which the test prompt from the functionality entry resulted in the generated response matching the testing response.

In Block 316, a determination is made if a conflict is detected. Specifically, a determination is made whether the accuracy level is below an acceptance threshold for any of the functionality entries (e.g., new functionality entry or existing functionality entry). If the accuracy level is below a threshold, a conflict is detected. For example, based on the accuracy level, a conflict between the current version of the new functionality entry and an existing functionality entry may be detected. If a conflict is detected, the flow may proceed to Block 318.

In Block 318, if a conflict is detected, the owner interface may be populated with information regarding the conflict to obtain a revised version of the new functionality entry. For example, the conflict may be identified in the owner interface. A recommendation for correcting the conflict may also be identified and populated into the owner interface. The owner of the new functionality entry and the owner of the existing functionality entry may be prompted through the owner interface to update the respective functionality entry.

For example, in some embodiments, an alert is generated for the owner of the existing functionality entry. The alert notifies the owner of the existing functionality entry that a conflict exists. Thus, the existing functionality entry owner may also update the existing functionality entry through the owner interface.

If a conflict is not detected, the flow may proceed to Block 322. In Block 322, the new functionality entry is stored in the code repository. Storing the new functionality entry in the code repository may be performed as discussed above with respect to Block 310. If any revisions are made through the process of FIG. 3, then the most revised version of the functionality entry is stored.

After storing the functionality entry, a search of the code repository may result in identification and presenting of the code examples. Via a search interface, a consumer prompt requests a set of code examples for a particular functionality. The prompt manager with the RAG system may identify the subset of functionality entries in the code repository that are potentially matching and add the subset to the prompt as described above. The LLM processes the consumer prompt by identifying functionality entries in the subset having metadata matching the consumer prompt to obtain matching metadata. The LLM selects the functionality entry corresponding to the matching metadata. Thus, the functionality entry includes at least one code example with the particular functionality. The LLM selects a code example from the at least one code example based on the consumer prompt and the matching metadata. The code example is presented in the search interface.

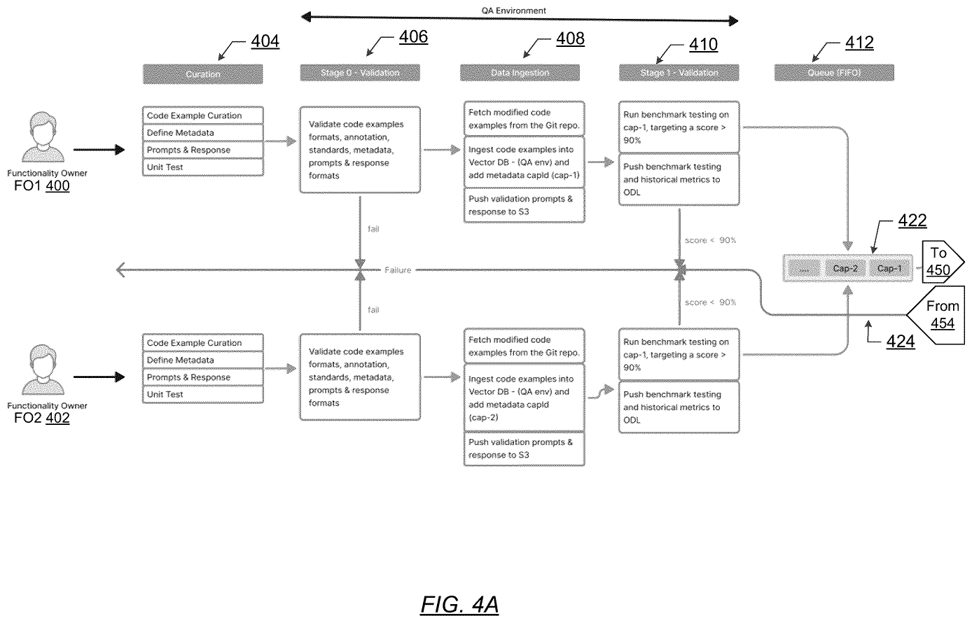

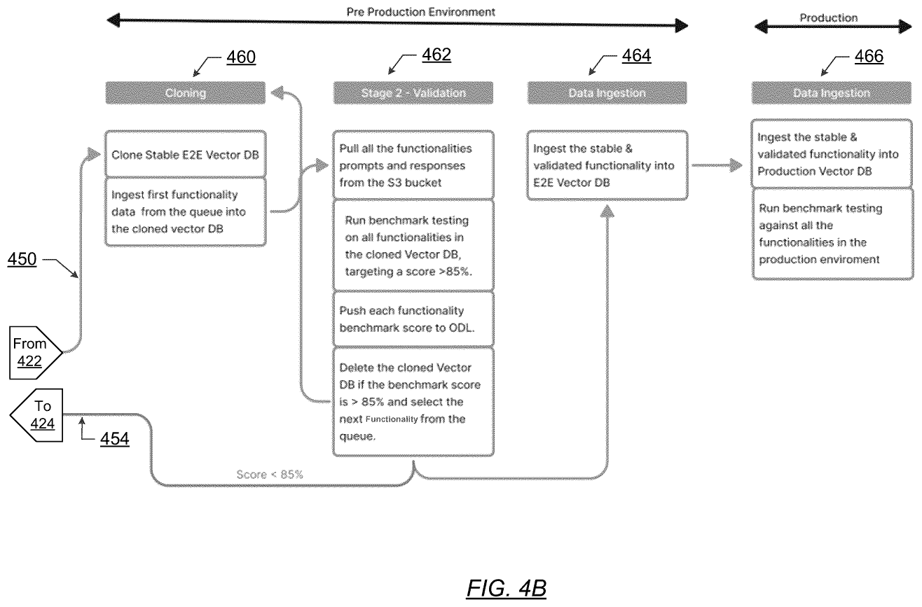

FIG. 4A and FIG. 4B show an example in accordance with one or more embodiments. The following example is for explanatory purposes only and not intended to limit the scope of one or more embodiments. In the example, starting with FIG. 4A, consider the scenario in which two functionality owners exist (i.e., functionality owner 1 (FO1) (400), functionality owner 2 (FO2 ) (402)) are providing different functionalities. During the curation stage (404), the functionality owners provide respective functionality entries that include code examples, define metadata, prompts and responses, and unit tests through the owner interface.

A stage 0 validation (406) is independently performed on each functionality entry. Failure of the stage 0 validation is reverted to the functionality owner through the owner interface.

Once stage 0 validation is performed (406), data ingestion (408) is performed. Data ingestion includes various operations to store the functionality entry into the various parts of the clone code repository. For example, vectorization is performed on the metadata and the examples to generate vectors to add to the vector database.

Stage 1 validation (410) includes sending the example prompts of only the corresponding functionality entry to determine whether the corresponding response is received. Namely, at stage 1 validation, a mix of example prompts from different functionality entries are not sent. In some embodiments, a 90% threshold is tested. Failure of the 90% threshold causes a reversion back to the functionality owner.

The passing functionality entries are transmitted to a FIFO queue (412) for further testing. The example continues with line (450) in FIG. 4B. Failure reverts to from line (454) to line (424) in FIG. 4A to interact with the functionality owners via the owner interface.

FIG. 4B continues the example with collective stage validation. In the collective stage validation, both functionality entries are added to a cloned code repository (460). Stage 2 validation (462) is performed. In the stage 2 validation (462), the prompts and response pairs from different functionality entries are added to a bucket. A determination is made whether at least 85% of the prompts to the LLM result in the LLM generating a correct response. If less than 85% is generated, then a conflict is determined to exist. For example, the conflict may be in an acronym that is used. In such a scenario, the respective functionality entry owners are notified through the owner interface (454). Otherwise, if more than a threshold passes, the functionality entry is ingested into the code repository. Data ingestion includes adding the functionality entry to the vector database (464) and running benchmark testing (466).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving, from an owner computing system via an owner interface, a first version of a new functionality entry comprising a plurality of new pairs, the plurality of new pairs each comprising a new prompt and a new response referencing a corresponding new code example of a plurality of new code examples;
storing the new functionality entry in a clone of a code repository, the clone and the code repository comprising a plurality of existing functionality entries comprising a plurality of existing pairs, the plurality of existing pairs each comprising an existing prompt and an existing response referencing a corresponding existing code example of the plurality of existing code examples;
processing, by an LLM using information from the clone, a set of test prompts selected from the plurality of new pairs and the plurality of existing pairs and comprising the new prompt and the existing prompt, wherein processing the set of test prompts generates a set of generated responses;
identifying an accuracy level of the set of generated responses in selecting, from the clone, a corresponding code example for each of the set of test prompts;
detecting, based on the accuracy level, a conflict between the first version of the new functionality entry and an existing functionality entry of the plurality of existing functionality entries; and
populating the owner interface with information regarding the conflict to obtain a second version of the new functionality entry.

2. The method of claim 1, further comprising:
storing the second version in the new functionality entry in the code repository.

3. The method of claim 1, further comprising:
performing an initial stage of validating the new functionality entry, wherein performing the initial stage of validating comprises:
testing the corresponding new code example to comply with a first set of requirements,
testing metadata and at least one unit test for complying with a second set of requirements,
identifying in the owner interface at least one of the first set of requirements and the second set of requirements failed by the new functionality entry, and
receiving a correction of the new functionality entry to generate the first version.

4. The method of claim 1, further comprising:
receiving, via a search interface, a consumer prompt requesting a set of code examples for a particular functionality;
processing, by the LLM, the consumer prompt by using a plurality of functionality entries for metadata in the code repository matching the consumer prompt to obtain matching metadata, wherein the plurality of functionality entries comprises the new functionality entries and the plurality of existing functionality entries;
selecting, by the LLM, a functionality entry corresponding to the matching metadata, the functionality entry comprising at least one code example with the particular functionality;
selecting, by the LLM, a code example from the at least one code example based on the consumer prompt and the matching metadata; and
presenting, in the search interface, the code example.

5. The method of claim 1, wherein the code repository comprises a vector database indexed by a retrieval augmented generation (RAG) indexer, and a storage server, and wherein the method further comprises:
indexing the plurality of new code examples and corresponding metadata by the RAG indexer to generate a plurality of vectors,
storing the plurality of vectors in the vector database; and
storing the plurality of new code examples, the corresponding metadata, and the plurality of new pairs in the storage server.

6. The method of claim 5, wherein processing a test prompt in the set of test prompts comprises:
searching, by a RAG system, the vector database with the test prompt to identify a subset of vectors of the plurality of vectors;
identifying, by an LLM, a vector from the subset that corresponds to metadata and the code example to obtain a generated response;
obtaining the code example from the storage server; and
providing the generated response with the code example.

7. The method of claim 1, further comprising:
transmitting an alert to an owner of the existing functionality entry to notify the owner of the conflict; and
populating the owner interface with information regarding the conflict to obtain a revised version of the existing functionality entry.

8. A system comprising:
at least one computer processor;
a clone of a code repository comprising a plurality of existing functionality entries comprising a plurality of existing pairs, the plurality of existing pairs each comprising an existing prompt and an existing response referencing a corresponding existing code example of the plurality of existing code examples;
an interface executing on the at least one computer processor configured to receive, from an owner computing system, a first version of a new functionality entry comprising a plurality of new pairs, the plurality of new pairs each comprising a new prompt and a new response referencing a corresponding new code example of a plurality of new code examples;
a code ingest process executing on the at least one computer processor configured to perform operations comprising:
storing the new functionality entry in the clone of the code repository,
identifying an accuracy level of a set of generated responses in selecting, from the clone, a corresponding code example for each of a set of test prompts,
detecting, based on the accuracy level, a conflict between the first version of the new functionality entry and an existing functionality entry of the plurality of existing functionality entries; and
populating an owner interface with information regarding the conflict to obtain a second version of the new functionality entry; and
a large language model (LLM) configured to process, by using information from the clone, the set of test prompts selected from the plurality of new pairs and the plurality of existing pairs and comprising the new prompt and the existing prompt, wherein processing the set of test prompts generates the set of generated responses.

9. The system of claim 8, wherein the operations further comprise:
storing the second version in the new functionality entry in the code repository.

10. The system of claim 8, wherein the operations further comprise:
performing an initial stage of validating the new functionality entry, wherein performing the initial stage of validating comprises:
testing the plurality of new code examples to comply with a first set of requirements,
testing metadata and at least one unit test for complying with a second set of requirements,
identifying in the owner interface at least one of the first set of requirements and the second set of requirements failed by the new functionality entry, and
receiving a correction of the new functionality entry to generate the first version.

11. The system of claim 8, wherein the interface is further configured to:
receive, via a search interface, a consumer prompt requesting a set of code examples for a particular functionality,
presenting, in the search interface, a selected code example, and
wherein the LLM is further configured to:
process, by the LLM, the consumer prompt by using a subset of a plurality of functionality entries for metadata in the code repository matching the consumer prompt to obtain matching metadata, wherein the plurality of functionality entries comprises the new functionality entry and the plurality of existing functionality entries,
select, by the LLM, a functionality entry corresponding to the matching metadata, the functionality entry comprising at least one code example with the particular functionality, and
select, by the LLM, the code example from the at least one code example based on the consumer prompt and the matching metadata to obtain the selected code example.

12. The system of claim 8, wherein the code repository comprises a vector database indexed by a retrieval augmented generation (RAG) indexer, and a storage server, and wherein the operations further comprise:
searching, by a RAG system, the vector database with the test prompt to identify a subset of vectors of the plurality of vectors;
identifying, by an LLM, a vector from the subset that corresponds to metadata and the code example to obtain a generated response;
obtaining the code example from the storage server; and
providing the generated response with the code example.

13. The system of claim 12, wherein processing a test prompt in the set of test prompts comprises:
searching, by the LLM, the vector database with the test prompt to identify a vector of the plurality of vectors that corresponds to metadata and the corresponding code example;
obtaining the corresponding code example from the storage server to obtain a generated response; and
providing the generated response with the corresponding code example.

14. The system of claim 8, wherein the interface is further configured to:
transmit an alert to an owner of the existing functionality entry to notify the owner of the conflict, and
populate the owner interface with information regarding the conflict to obtain a revised version of the existing functionality entry.

15. A method comprising:
receiving, via a search interface, a consumer prompt requesting a set of code examples for a particular functionality;
processing, by an LLM, the consumer prompt by identifying, from a subset of a plurality of functionality entries in a code repository, matching metadata matching the consumer prompt;
selecting a functionality entry corresponding to the matching metadata, the functionality entry comprising at least one code example with the particular functionality;
selecting a code example from the at least one code example based on the consumer prompt and the matching metadata; and
presenting, in the search interface, the code example.

16. The method of claim 15, wherein the code repository comprises a vector database indexed by a retrieval augmented generation (RAG) indexer, and a storage server, and wherein the method further comprises:
indexing a plurality of code examples and corresponding metadata by the RAG indexer to generate a plurality of vectors,
storing the plurality of vectors in the vector database, and
storing the plurality of code examples, the corresponding metadata, and a plurality of pairs of example requests and responses in the storage server.

17. The method of claim 16, further comprising:
searching, by a RAG system, the vector database with the test prompt to identify a subset of vectors of the plurality of vectors;
identifying, by an LLM, a vector from the subset that corresponds to metadata and the code example to obtain a generated response;
obtaining the code example from the storage server; and
providing the generated response with the code example.

18. The method of claim 15, further comprising:
transmitting an alert to an owner of an existing functionality entry to notify the owner of a conflict between a new functionality entry and the existing functionality entry; and
populating an owner interface with information regarding the conflict to obtain a revised version of the existing functionality entry.

19. The method of claim 15, further comprising:
transmitting an alert to an owner of a new functionality entry to notify the owner of a conflict between the new functionality entry and an existing functionality entry; and
populating the owner interface with information regarding the conflict to obtain a revised version of the new functionality entry.

20. The method of claim 15, further comprising:
generating the clone of the code repository to test the plurality of functionality entries in the code repository.
